(19) United States
(12) Patent Application Publication
(10) Pub. No.: US 2019/0157788 A1
(43) Pub. Date: May 23, 2019

(54) TERMINAL FITTING AND CONNECTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Motohiro Ando, Yokkaichi, Mie (JP); Akio Kimura, Yokkaichi, Mie (JP); Kyohei Ida, Yokkaichi, Mie (JP)

(21) Appl. No.: 15/781,524

(22) PCT Filed: Nov. 28, 2016
(86) PCT No.: PCT/JP2016/085142

§ 371 Date: Jun. 5, 2018

(30) Foreign Application Priority Data
Dec. 17, 2015 (JP) 2015-245968

(51) Int. Cl. H01R 13/24; H01H 1/24; H01R 13/33

(52) U.S. Cl. CPC H01R 13/2421; H01H 1/242; H01H 13/28; H01H 1/245; H01R 13/33

(57) ABSTRACT

A terminal fitting includes an electric contact member (20) which has a facing surface (21) facing a contact surface (81) disposed on a counterpart terminal (80) and is connected to an external circuit. An obliquely wound coil spring (40) has an electroconductive wire member (41) wound a plurality of times so that the winding surface is oblique with respect to a coil axis L. Both ends of the electroconductive wire member (41) are fixed to the electric contact member (20) in such an attitude that the coil axis L is parallel to the facing surface (21) of the electric contact member (20), and the obliquely wound coil spring (40) is to be sandwiched between the counterpart terminal (80) and the electric contact member (20) when the counterpart terminal (80) and the electric contact member (20) come close to each other.

### BACKGROUND

### Field of the Invention

This specification relates to a terminal fitting and a connector containing the terminal fitting.

### Description of the Related Art

Electric connection in an automobile is obtained by causing a terminal to be brought into contact with a facing contact point by striking the facing contact point. However, a contact failure may occur when a foreign material adheres between the contact points. For this reason, Japanese Unexamined Patent Publication No. 2002-274290, discloses a connector where both contact points are slid together when striking between the contact points to remove a foreign material between the contact points.

More specifically, Japanese Unexamined Patent Publication No. 2002-274290 discloses a power supply device that has terminal plates facing each other in a case, and a coil spring is sandwiched and compressed between the terminal plates in a female-side junction. A leaf spring member having elasticity is disposed on a terminal plate on a side exposed to the outside. This leaf spring member has a sloping free end portion that easily can be deformed elastically by being bent after extending out from the terminal plate, and a male-side contact point and a female-side contact point slide together when both contact points are in contact with each other to remove a foreign material between the contact points.

However, the configuration in Japanese Unexamined Patent Publication No. 2002-274290 cannot be used for a large current. This is because the plate thickness of a leaf spring member becomes large in a large current application and has high rigidity. Thus, a bent portion cannot be deformed, and a free end portion is not be freely elastically deformable. For this reason, the free end portion is deformed elastically by contact with a male-side contact point and cannot slide. Therefore, a foreign material is not removed.

### SUMMARY

A terminal fitting disclosed in the specification includes an electric contact member that has a facing surface configured to face a contact surface disposed on a counterpart terminal. The electric contact member is to be connected to an external circuit. An obliquely wound coil spring has an electroconductive wire member wound plural times so that the winding surface is oblique with respect to a coil axis. Both ends of the electroconductive wire member are fixed to the electric contact member in such an attitude that the coil axis is parallel to the facing surface of the electric contact member. The obliquely wound coil spring is to be sandwiched between the counterpart terminal and the electric contact member when the counterpart terminal and the electric contact member come close to each other.

The obliquely wound coil spring has both the ends fixed to the electric contact member. Additionally, the coil axis is arranged along a facing surface of the electric contact member, and a winding surface is oblique with respect to the coil axis. For this reason, when the counterpart terminal and the electric contact member come close to each other, the obliquely wound coil spring is sandwiched between the contact surface of the counterpart terminal and the facing surface of the electric contact member so that the counterpart terminal and the electric contact member are connected electrically to each other.

In the connection state, when the counterpart terminal and the electric contact member move to approach each other, the obliquely wound coil spring is deformed such that the winding surface is tilted further against the elastic force thereof. In this process, on a contact portion between the obliquely wound coil spring and the contact surface of the counterpart terminal and a contact portion between the obliquely wound coil spring and the facing surface of the electric contact member, a slippage moving phenomenon occurs such that the oblique wound coil spring rubs the surfaces. Thus, even if foreign materials are present on the surfaces, the foreign materials are scraped away.

A connector may include a connector housing capable of containing a terminal fitting, and the connector housing may be configured to have an opening through which the counterpart terminal can enter to contact the obliquely wound coil spring. In this configuration, the connector housing protects the terminal fitting and also allows the counterpart terminal to enter from the opening for connection.

According to the terminal fitting disclosed in the specification, a foreign matter between the terminal fitting and the counterpart terminal can be removed.

### BRIEF DESCRIPTION OF THE DRAWINGS

FIG. 1 is a sectional view a state obtained before a connector according to an embodiment is fitted on a counterpart connector.

FIG. 2 is a sectional view showing a state in which the connector and the counterpart connector are close to each other.

FIG. 3 is a sectional view showing a state in which the connector is completely fitted on the counterpart connector.

### DETAILED DESCRIPTION

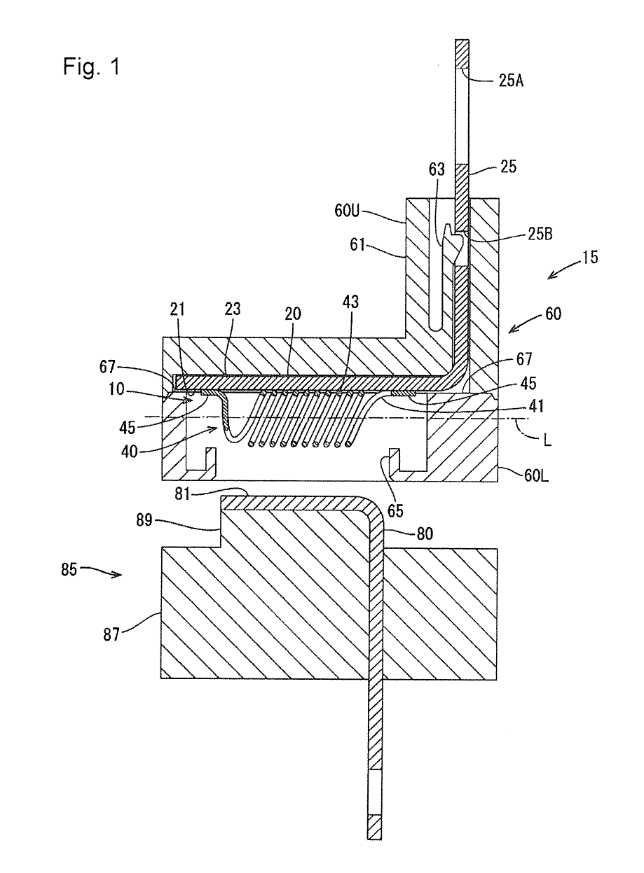

An embodiment will be described below with reference to FIG. 1 to FIG. 3.

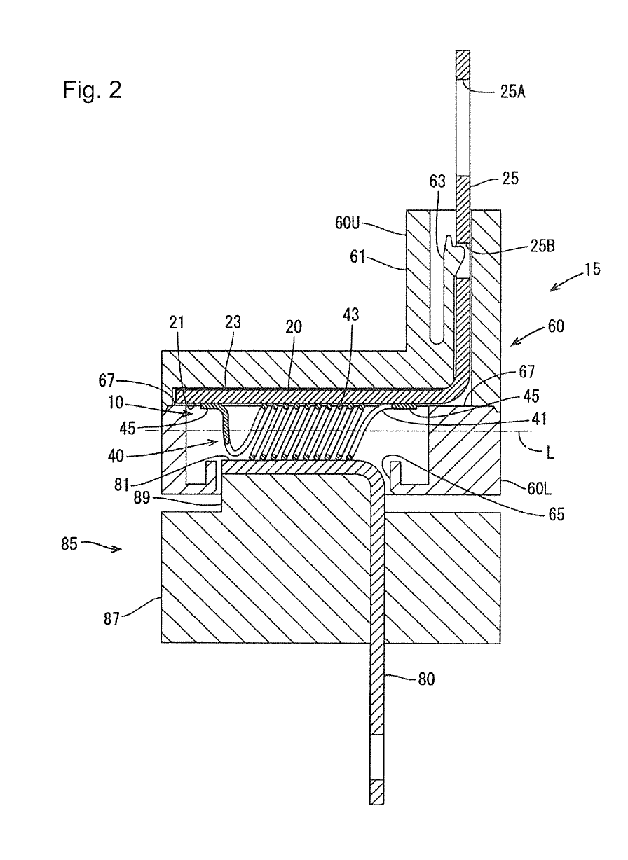

A terminal fitting 10 according to the embodiment is connected electrically to a counterpart terminal 80 by being brought into contact with the counterpart terminal 80. The terminal fitting 10 is contained in a connector housing 60, and a connector 15 includes the terminal fitting 10 and the connector housing 60. The terminal fitting 10 includes an electric contact member 20 and an obliquely wound coil spring 40. In the following description, the invention will be explained on the assumption that the upper side in FIG. 1 and the lower side (counterpart terminal 80 side) in FIG. 1 are defined as an upper side and a lower side, respectively. Furthermore, the left side in FIG. 1 and the right side (external connection portion 25 side) in FIG. 2 are defined as a front side and a rear side, respectively.

The electric contact member 20, as shown in FIG. 1, is obtained by pressing a metal plate material such as a copper alloy, and has a substantially L shape. The electric contact member 20 includes a receiving portion 23 with a facing surface 21 that is in contact with the obliquely wound coil spring 40. An external connection portion 25 rises up at a position perpendicular to the facing surface 21 and is connected to an external circuit. The receiving portion 23 is planar and has a width in the forward and backward directions that is longer than a size in the axial direction (forward and backward directions) of the obliquely wound spring 40. The facing surface 21 is defined by a lower surface of the receiving portion 23. The external connection portion 25 has a long bolt hole 25A and a locking hole 25B locked on the connector housing 60.

The obliquely wound coil spring 40, as shown in FIG. 1, has a coil shape obtained by winding an electroconductive wire member 41 a plurality of times. The obliquely wound coil spring 40 is different from an ordinary coil spring, and is wound so that winding surfaces of coils configuring the spring are oblique with respect to a coil axis L. The obliquely wound coil spring 40 is deformed such that, when a load is applied on an outer peripheral portion 43 of the obliquely wound coil spring 40, each of the winding surfaces of the coils is tilted to be in a state in which each of the winding surfaces of the coils is further inclined with respect to the coil axis L to reduce the height of the spring (a size in a direction perpendicular to an axis direction of the spring). The obliquely wound coil spring 40 has a nonlinear region in which a spring load does not change a large amount when the obliquely wound coil spring 40 is changed in amount of displacement (amount of displacement of the height of the spring).

Both ends 45 of the electroconductive wire member 41 of the obliquely wound coil spring 40 are fixed to the electric contact member 20 in such an attitude that the coil axis L is substantially parallel with the facing surface 21. Both ends 45 of the obliquely wound coil spring 40 are extended and fixed to the electric contact member 20 by welding. Both ends of the obliquely wound coil spring 40 are fixed to have redundant portions being long enough not to effect tensile strength caused by fixed portions when the obliquely wound coil spring 40 is deformed. The amount of displacement of the obliquely wound coil spring 40 is about 40% at most. For this reason, the redundant portions need not be long enough not to hold the obliquely wound coil spring 40 at a normal position. The obliquely wound coil spring 40 has an elliptical shape when viewed from a winding direction, and the obliquely wound coil spring 40 is arranged such that a minor axis of the elliptical shape is along the vertical direction.

The connector housing 60, as shown in FIG. 1, is made of a synthetic resin and is configured by combining an upper-half 60U and a lower-half 60L that are vertically divided and.

The upper-half 60U of the connector housing 60 has a deriving portion 61 deriving the external connection portion 25 out of the connector housing 60. A lance 63 is disposed inside the deriving portion 61. The lance 63 is fit in and locked on the locking hole 25B of the external connection portion 25 to lock the electric contact member 20 in the connector housing 60.

An opening 65 is formed in the lower-half part 60L of the connector housing 60 and can receive a counterpart terminal 80 into the connector housing 60. The opening 65 is formed at a position where the obliquely wound coil spring 40 of the contained terminal fitting 10 is disposed and has a size in the forward and backward directions equal to a size in the forward and backward directions of the obliquely wound coil spring 40 except for the ends 45. The opening 65 allows the obliquely wound coil spring 40 to be exposed downward and allows a fitting 89 to enter.

Placing surfaces 67 are disposed on the lower-half 60L of the connector housing 60 and receive the front and rear ends of the receiving part 23 of the electric contact member 20. The placing surfaces 67 are disposed on the front and rear sides of the opening 65, and the electric contact member 20 is sandwiched between the placing surface 67 and the upper-half part 60U to fix the electric contact member 20.

The counterpart connector 85, as shown in FIG. 1, includes the counterpart terminal 80 and a counterpart housing 87. The counterpart terminal 80 is made of an electroconductive metal and is formed in a substantially L shape by bending a vertical plate forward substantially at a right angle. An upper surface of the counterpart terminal 80 on a side facing the electric contact member 20 serves as a contact surface 81.

The counterpart terminal 80 is held in the housing 87 by insert shaping. The contact surface 81 is held by the fitting 89. The fitting 89 enters into the opening 65 to fit the connector 15 and the counterpart connector 85 on each other. A length between the facing surface 21 of the electric contact member 20 and the contact surface 81 of the counterpart terminal 80 is determined such that the obliquely wound coil spring 40 is used in the nonlinear region in a state in which the connector 15 and the counterpart connector 85 are completely fit on each other.

The terminal fitting 10 and the connector 15 according to the embodiment have the above configuration, and the operations thereof will be described below.

Both the ends 45 of the obliquely wound coil spring 40 are welded on the electric contact member 20 to hold the obliquely wound coil spring 40 on the electric contact member 20 before the counterpart terminal 80 is pressed against the obliquely wound coil spring 40, as shown in FIG. 1. The obliquely wound coil spring 40 is held in such an attitude that the coil axis L of the obliquely wound coil spring 40 is substantially parallel to the facing surface 21 of the electric contact member 20 such that the obliquely wound coil spring 40 is along the electric contact member 20.

The terminal fitting 10 is contained in the connector housing 60. The locking hole 25B of the electric contact member 20 is locked by the lance 63, and the front and rear ends of the receiving portion 23 are sandwiched between the placing surface 67 and the upper-half 60U to fix the terminal fitting 10 in the connector housing 60. The surface of the terminal fitting 10 except for the opening 65 is covered and protected by the connector housing 60.

As shown in FIG. 2, the connector 15 and the counterpart connector 85 come relatively close to each other, the contact surface 81 of the counterpart terminal 80 is brought into contact with the outer peripheral portion 43 of the obliquely wound coil spring 40. In this state, the obliquely wound coil spring 40 is sandwiched between the contact surface 81 of the counterpart terminal 80 and the facing surface 21 of the electric contact member 20, and the counterpart element 80 and the electric contact member 20 are connected electrically to each other. At this time, the electric contact member 20 and the counterpart terminal 80 are in contact with the obliquely wound coil spring 40 at many contact points to obtain a large number of contact points, and contact resistance can be reduced.

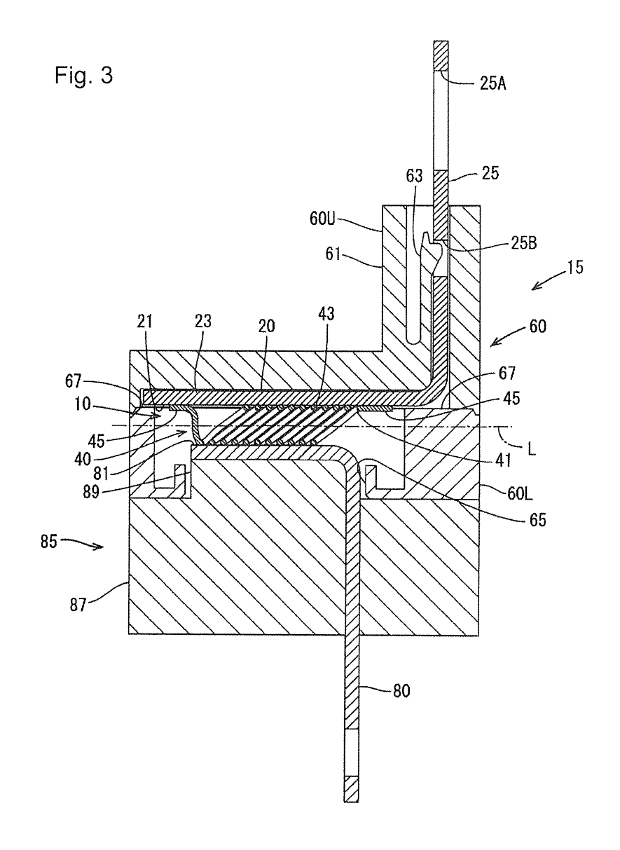

The connector 15 and the counter connector 85 come closer to each other so that the counterpart terminal 80 and the electric contact member 20 come closer to each other in the connection state. Thus, a pressing force from the counterpart terminal 80 acts on the obliquely wound coil spring 40. In response to the pressing force, as shown in FIG. 3, the obliquely wound coil spring 40 is deformed such that the winding surface is tilted further against the elastic force of the obliquely wound coil spring 40 with respect to the coil axis L. In this process, a slippage moving phenomenon occurs at the contact portion between the obliquely wound coil spring 40 and the contact surface 81 of the counterpart terminal 80 and also at the contact portion between the obliquely wound coil spring 40 and the facing surface 21 of the electric contact member 20. Thus, the oblique wound coil spring 40 rubs the surfaces. Thus, any foreign materials that may be present on the surfaces 81 and 21 are scraped away. Both ends 45 of the obliquely wound coil spring 40 are fixed to have redundant portions. Hence, there is no risk that tensile strength is generated by the fixed ends 45 when the winding surface is tilted to influence deformation of the obliquely wound coil spring 40.

As shown in FIG. 3, in a state in which the connector 15 and the counterpart connector 85 are fit completely on each other, the obliquely wound coil spring 40 is designed to be used in the nonlinear region thereof. For this reason, it is assumed that a relative distance between the electric contact member 20 and the counterpart terminal 80 is changed due to vibration or the like to change pressing force from the counterpart terminal 80 so as to change the height of the obliquely wound coil spring 40. Even in this case, the obliquely wound coil spring 40 has a spring load that is not largely changed in the nonlinear region. Thus, the spring load between the electric contact member 20 and the counterpart terminal 80 does not change. For this reason, even if the counterpart terminal 80 moves due to vibration or the like, an influence on the contact resistance caused by moving of the counterpart terminal 80 can be suppressed. Since the obliquely wound coil spring 40 secures a contact pressure and has an electroconductive function, the number of parts can be reduced, and a reduction in size can be achieved.

As described above, the obliquely wound coil spring 40 having both ends 45 fixed to the electric contact member 20 is arranged in such an attitude that the coil axis L is along the facing surface 21 of the electric contact member 20 and the winding surface is oblique with respect to the coil axis L. For this reason, when the counterpart terminal 80 comes relatively close to the terminal fitting and is pressed, the obliquely wound coil spring 40 is deformed such that the winding surface is tilted farther against the elastic force of the obliquely wound coil spring 40. In this process, a slippage moving phenomenon occurs such that the oblique wound coil spring 40 rubs the surfaces of the facing surface 21 and the contact surface 81. Thus, any foreign materials that are present on the surfaces 21 and 81 are scraped away. Since the obliquely wound coil spring 40 secures a contact pressure and has an electroconductive function, the number of parts can be reduced, and a reduction in size can be achieved.

The is not limited to the embodiment explained by the above description and the drawings, and, for example, includes the following various embodiments.

In the embodiment described above, both the ends 45 of the obliquely wound coil spring 40 are fixed to the electric contact member 20 by welding. However, both the ends 45 may be fixed by another method such as soldering.

In the embodiment described above, the coil axis L of the obliquely wound coil spring 40 is arranged to extend in the forward and backward directions. However, the coil axis L may extend in the width directions of the electric contact member 20.

In the embodiment described above, the external connection portion 25 is connected to an external circuit by being derived out of the connector housing 60. However, a terminal fitting may be connected to an external circuit by connecting a wire connected to the external circuit to an electric contact member.

### LIST OF REFERENCE SIGNS

10 . . . terminal fitting
20 . . . electric contact member
21 . . . facing surface
23 . . . receiving portion
25 . . . external connection portion
40 . . . obliquely wound coil spring
41 . . . electroconductive wire member
45 . . . both ends
60 . . . connector housing
60U . . . upper-half
60L . . . lower-half
65 . . . opening
80 . . . counterpart terminal
81 . . . contact surface
85 . . . counterpart connector
89 . . . fitting
CL . . . coil axis

1. A terminal fitting comprising:
an electric contact member having a facing surface configured to face a contact surface disposed on a counterpart terminal, wherein the electric contact member is to be connected to an external circuit; and
an obliquely wound coil spring having a coil shape in which an electroconductive wire member is wound a plurality of times so that the winding surface is oblique with respect to a coil axis, both ends of the electric contact member are fixed to the electric contact member in such an attitude that the coil axis is parallel to the facing surface of the electric contact member, and the obliquely wound coil spring is to be sandwiched between the counterpart terminal and the electric contact member and the winding surface is tilted to be in a state in which the winding surface is further inclined with respect to the coil axis when the counterpart terminal and the electric contact member come close to each other.

2. A connector including a connector housing having the terminal fitting of claim 1 therein, wherein
the connector housing has an opening through which the counterpart terminal is capable of entering to be in contact with the obliquely wound coil spring.
